(19) United States
(12) Patent Application Publication
(10) Pub. No.: US 2026/0267054 A1
(43) Pub. Date: Sep. 10, 2026

(54) LIGHTING DEVICE, LIGHT GUIDE PLATE, AND DISPLAY DEVICE

(71) Applicant: Shanghai Tianma Micro-Electronics Co., Ltd., Shanghai (CN)

(72) Inventor: Hidenori IKENO, Kawasaki (JP)

(73) Assignee: Shanghai Tianma Micro-Electronics Co., Ltd., Shanghai (CN)

(21) Appl. No.: 19/553,604

(22) Filed: Mar. 2, 2026

(30) Foreign Application Priority Data
Mar. 5, 2025 (JP) 2025-034693

(51) Int. Cl. F21V 8/00

(52) U.S. Cl. CPC G02B 6/0055; G02B 6/0051

(57) ABSTRACT

The present application discloses a lighting device, a light guide plate, and a display device. The lighting device includes a light guide plate and a light source. The light source emits visible light to be incident to the light guide plate. The light guide plate has a first main surface through which visible light is output, and a second main surface opposite to the first main surface. The second main surface is provided with at least one light-distribution control structure that combines at least one light reflector and at least one infrared absorber.

### CROSS-REFERENCE TO RELATED APPLICATIONS

This application claims the benefit of Japanese Patent Application No. 2025-34693, filed on Mar. 5, 2025, the entire disclosure of which is incorporated by reference herein.

### FIELD OF THE INVENTION

This application relates to a lighting device, a light guide plate, and a display device.

### BACKGROUND OF THE INVENTION

Korean Patent No. 10-2551583 discloses a structure that includes a light guide plate having recesses to enable extraction of visible light to the side of a liquid crystal panel. The recesses are optical patterns on the main surface of the light guide plate opposite to the main surface facing the liquid crystal panel. The optical patterns are provided with reflective layers on their surfaces. The structure disclosed in Korean Patent No. 10-2551583 includes no diffusion plate between the light guide plate and the liquid crystal panel.

A typical liquid crystal display device including an infrared camera disposed behind a backlight unit cannot enable both appropriate capturing and appropriate display of images. For example, the structure disclosed in Korean Patent No. 10-2551583, if including such an infrared camera, would have defects, such as noise in camera images and moire or luminance unevenness in the screen. Other structures including diffusion plates suffer from blurring of camera images.

### SUMMARY OF THE INVENTION

A lighting device according to a first aspect of the present disclosure includes a light guide plate and a light source to emit visible light to be incident to the light guide plate. The light guide plate includes a first main surface through which the visible light is output and a second main surface opposite to the first main surface. The second main surface includes at least one light-distribution control structure that combines at least one light reflector and at least one infrared absorber.

A light guide plate according to a second aspect of the present disclosure includes a first main surface through which visible light is output, a second main surface opposite to the first main surface, and an end face intersecting both the first main surface and the second main surface. The end face being able to receive visible light emitted from a light source. The second main surface has a specific region provided with at least one light-distribution control structure that combines at least one light reflector and at least one infrared absorber, and the specific region is able to reflect at least part of visible light propagating within the light guide plate toward the first main surface, absorb at least part of infrared rays emitted from an exterior of the light guide plate to the second main surface, and transmit at least part of infrared rays propagating from the first main surface to the second main surface.

A display device according to a third aspect includes a light guide plate including a first main surface through which visible light is output, a diffusion plate stacked on the first main surface of the light guide plate, a light source to emit visible light to be incident to the light guide plate, and a display panel to display an image using the visible light output from the light guide plate and the diffusion plate. The light guide plate includes the first main surface and a second main surface opposite to the first main surface, and the second main surface is provided with at least one light-distribution control structure that combines at least one light reflector and at least one infrared absorber.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a front view of a liquid crystal display device according to Embodiment 1;

FIG. 2 is a sectional view taken along the line Al-Al of FIG. 1;

FIG. 3 is a sectional view for describing the diameter of a through hole;

FIG. 4 is a sectional view for describing the size of light-distribution control patterns;

FIG. 5A is a front view for describing the width of the light-distribution control patterns;

FIG. 5B is another front view for describing the width of the light-distribution control patterns;

FIG. 5C is another front view for describing the width of the light-distribution control patterns;

FIG. 5D is another front view for describing the width of the light-distribution control patterns;

FIG. 6A illustrates a process of fabricating a light guide plate from an acrylic plate;

FIG. 6B illustrates the process of fabricating a light guide plate from an acrylic plate;

FIG. 6C illustrates the process of fabricating a light guide plate from an acrylic plate;

FIG. 6D illustrates the process of fabricating a light guide plate from an acrylic plate;

FIG. 6E illustrates the process of fabricating a light guide plate from an acrylic plate;

FIG. 7A illustrates a process of fabricating a light guide plate from a glass plate;

FIG. 7B illustrates the process of fabricating a light guide plate from a glass plate;

FIG. 7C illustrates the process of fabricating a light guide plate from a glass plate;

FIG. 7D illustrates the process of fabricating a light guide plate from a glass plate;

FIG. 7E illustrates the process of fabricating a light guide plate from a glass plate;

FIG. 8 is a diagram for describing a liquid crystal display device according to Embodiment 2;

FIG. 9A is a diagram for describing a liquid crystal display device according to Embodiment 3;

FIG. 9B is a diagram for describing a unit reflector of the liquid crystal display device according to Embodiment 3;

FIG. 10 is a diagram for describing a liquid crystal display device according to Embodiment 4;

FIG. 11A is a diagram for describing a light-distribution control pattern in Embodiment 5;

FIG. 11B is another diagram for describing the light-distribution control pattern in Embodiment 5;

FIG. 12 illustrates an exemplary configuration of the light-distribution control pattern in Embodiment 5;

FIG. 13 illustrates an exemplary configuration of dot patterns in Embodiment 6; and

FIG. 14 illustrates an exemplary configuration of shading patterns in a modification.

### DETAILED DESCRIPTION OF THE INVENTION

The following describes the present disclosure in detail with reference to the accompanying drawings. The following description contains terms indicating specific directions and positions as required. Examples of the terms include “right”, “left”, “top”, “bottom”, “front”, “rear”, and other terms having similar meanings. These terms are used to facilitate understanding of the present disclosure referring to the drawings, and not intended to limit the technical scope of the present disclosure. The same reference symbols appearing in multiple drawings indicate the components or members identical or corresponding to each other.

### Embodiment 1

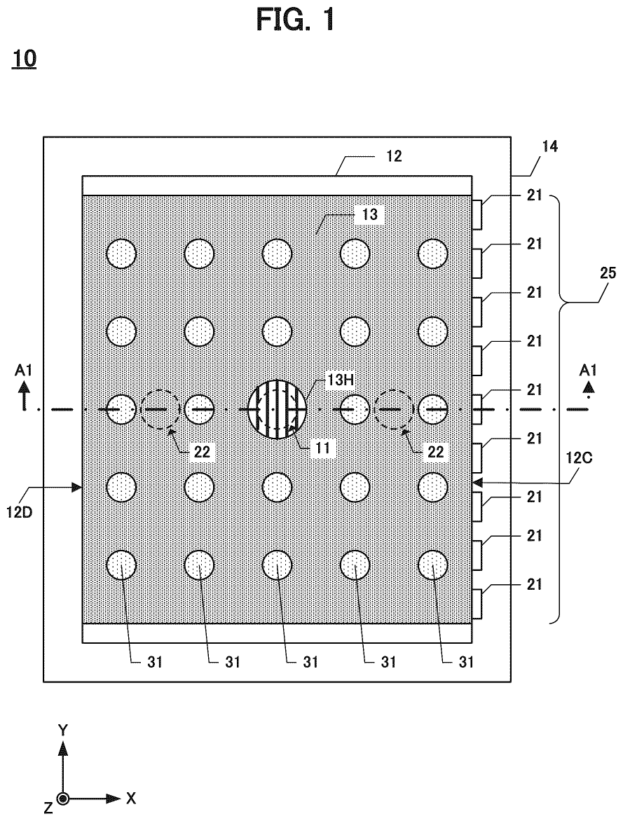

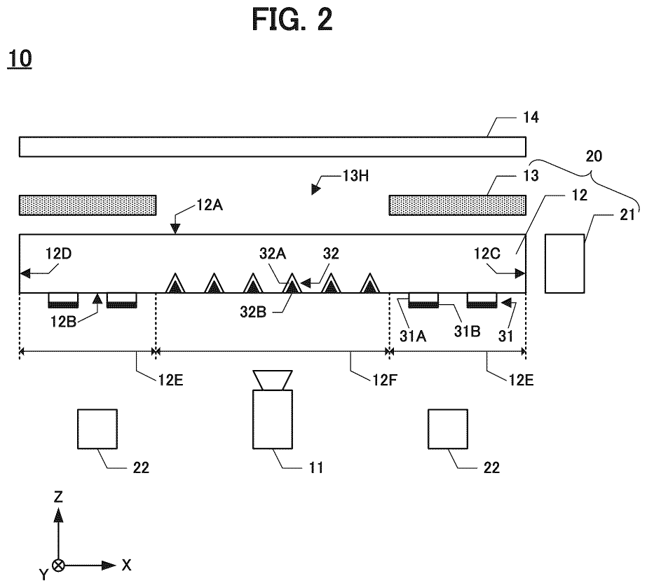

FIG. 1 is a front view of a liquid crystal display device 10 according to Embodiment 1. FIG. 2 is a sectional view taken along the line Al-Al of FIG. 1. Some of the components in FIGS. 1 and 2 are depicted at scales different from their actual sizes to facilitate understanding. The liquid crystal display device 10 includes an infrared camera 11, a light guide plate 12, a diffusion plate 13, and a liquid crystal panel 14. The liquid crystal display device 10 also includes light-emitting elements 21 and infrared sources 22. The light-emitting elements 21 in the present disclosure form a light source unit 25 serving as a linear light source. The light guide plate 12 and the diffusion plate 13, as well as the light-emitting elements 21 included in the light source unit 25, form a lighting unit 20 of the liquid crystal display device 10.

FIGS. 1 and 2 are provided with X, Y, and Z axes to facilitate understanding. For example, when the screen of the liquid crystal display device 10 illustrated in FIG. 1 is viewed in the front, the lateral direction is defined as the X-axis direction such that the direction from the left to right indicates the +X direction, the longitudinal direction is defined as the Y-axis direction such that the direction from the bottom to the top indicates the +Y direction, and the depthwise direction is defined as the Z-axis direction such that the direction from the rear to the front indicates the +Z direction. The side close to a viewer in the Z-axis direction is called the front or viewer's side. The side distant from the viewer in the Z-axis direction is called the rear side or the side behind the structure. The other drawings include similar expressions as required.

In the liquid crystal display device 10, the infrared camera 11 and the infrared sources 22 are disposed on the −Z side most distant from the viewer, the light guide plate 12 and the diffusion plate 13 are disposed in sequence from the rear to the front, and the liquid crystal panel 14 is disposed on the +Z side closest to the viewer. The lighting unit 20 serves as an edge-lit backlight. The lighting unit 20 can emit visible light through a light-emitting surface in the +Z direction corresponding to a first direction. The visible light indicates light having a wavelength of 380 nm or larger and 780 nm or smaller, for example. The visible light from the lighting unit 20 allows the liquid crystal panel 14 to display an image on the screen.

The infrared camera 11 detects infrared rays and can thus generate camera images. The infrared rays to be detected by the infrared camera 11 are emitted from the infrared sources 22, reflected by an imaging subject, pass through the liquid crystal panel 14 and the lighting unit 20 of the liquid crystal display device 10, and then enter a lens unit and an imaging element of the infrared camera 11. For example, the infrared camera 11 uses, as the infrared rays for image capturing, electromagnetic waves in the wavelength range of 800 nm or larger and 1,500 nm or smaller. Alternatively, the infrared camera 11 may be a sensor that detects infrared rays having a wavelength of 780 nm or larger to generate images, particularly, near infrared rays in the range of 780 to 2,500 nm.

The light guide plate 12 is made of a material having high visible light transmittance. Examples of the material of the light guide plate 12 include acrylic resins such as polymethylmethacrylate (PMMA), polycarbonate (PC) resins, glass, or any other materials. The light guide plate 12 has a main surface 12A and a main surface 12B. The main surface 12A functions as a light-emitting surface for emitting visible light in planar form in the +Z direction corresponding to the first direction. The main surface 12B functions as a light-reflecting surface for reflecting visible light in the −Z direction corresponding to a second direction opposite to the first direction. The main surface 12A is a first main surface of the light guide plate 12. The main surface 12B is a second main surface opposite to the first main surface of the light guide plate 12. The light guide plate 12 also has an end face 12C and an end face 12D. The end face 12C intersects the main surfaces 12A and 12B in the +X direction corresponding to a third direction. The end face 12D intersects the main surfaces 12A and 12B in the −X direction corresponding to a fourth direction opposite to the third direction. The end face 12C is opposite to the end face 12D.

The diffusion plate 13 is stacked on the main surface 12A of the light guide plate 12. The diffusion plate 13 diffuses the visible light emitted through the main surface 12A of the light guide plate 12, and thus reduces the luminance unevenness of visible light output from the lighting unit 20. The diffusion plate 13 is a plate-shaped or sheet-shaped member produced by adding light diffusing particles to a light guiding material and thus providing light diffusion properties to the material, for example. The diffusion plate 13 may have any structure provided that the diffusion plate 13 can expand the propagation direction of visible light transmitted therethrough and diffuse the light. Various examples of the structure may include a structure yielded by applying or stacking a material containing dispersed light diffusing particles on the surface, or a structure having protrusions and recesses on the surface. The diffusion plate 13 has a through hole 13H in the portion overlapping with the position of the infrared camera 11.

A typical example of the liquid crystal panel 14 is an active matrix panel including thin film transistors (TFTs). For example, the liquid crystal panel 14 includes a TFT substrate and an opposite substrate, a liquid crystal layer made of a liquid crystal material enclosed between the substrates, and a pair of polarizing plates that hold the TFT substrate and the opposite substrate therebetween. The liquid crystal panel 14 is a transmissive display panel that displays an image using visible light from the lighting unit 20. The liquid crystal panel 14 has transmissive portions, for transmitting visible light from the lighting unit 20, defined in accordance with a combination of the transparent segments of the TFT substrate, the liquid crystal layer, and color filters and a shading layer (black matrix) provided on the surface of the opposite substrate adjacent to the liquid crystal layer.

In the light source unit 25, the light-emitting elements 21 are light-emitting diodes (LEDs), for example. The light-emitting elements 21 in the present disclosure are aligned with their illumination surfaces facing the end face 12C. The light-emitting elements 21 may be any component capable of emitting visible light, other than LEDs. The visible light emitted from the individual light-emitting elements 21 enters the light guide plate 12 through the end face 12C. The light-emitting elements 21 thus serve as the light source unit 25 that emits visible light to be incident to the end face 12C of the light guide plate 12. The end face 12D of the light guide plate 12 opposed to the end face 12C may be covered with a side-surface reflective tape, or may be provided with light-emitting elements 21 like the end face 12C.

The infrared sources 22 emit infrared rays to an imaging subject, such as a driver of an automobile, for example. In the example illustrated in FIG. 1, the two infrared sources 22 are disposed behind the light guide plate 12 or on its −Z side, like the infrared camera 11. The infrared sources 22 emit infrared rays from the exterior of the light guide plate 12 to the main surface 12B. The diffusion plate 13 has the through hole 13H, and thus enables transmission of the infrared rays emitted from the infrared sources 22 and the infrared rays to be input to the infrared camera 11. The through hole 13H is preferably sized and positioned so as not to obstruct the field of view (FOV) of the infrared camera 11. The FOV indicates the range of image capturing of a camera and is also called a viewing angle or angle of view.

The light guide plate 12 illustrated in FIGS. 1 and 2 is provided with, as a first light-distribution control structure, reflective layers 31 in a first region 12E of the main surface 12B. FIG. 1 illustrates multiple reflective layers 31 having a circular shape of the same size and two-dimensionally arranged, although only the reflective layers 31 in the lowermost row accompany the reference symbols. The reflective layers 31 may have any pattern including all or some of the size, shape, number, positions, distribution, and occupancy in the first region 12E, appropriately designed depending on the visible-light output properties of the lighting unit 20, for example. The occupancy in the first region 12E indicates the ratio of the sum of the areas of the reflective layers 31 to the total area of the first region 12E. The reflective layers 31 may be uniformly distributed across the entire first region 12E, or nonuniformly distributed depending on their positions within the first region 12E. The first region 12E indicates the region of the main surface 12B of the light guide plate 12 except for the portion overlapping with the position of the infrared camera 11. In other words, the first region 12E of the main surface 12B of the light guide plate 12 corresponds to the area not provided with the infrared camera 11. The first region 12E of the main surface 12B is encompassed in a diffusing area not overlapping with the through hole 13H of the diffusion plate 13.

The light guide plate 12 illustrated in FIGS. 1 and 2 is provided with, as a second light-distribution control structure, light-distribution control patterns 32 in a second region 12F of the main surface 12B. The second region 12F indicates the region of the main surface 12B of the light guide plate 12 that encompasses the portion overlapping with the position of the infrared camera 11. In other words, the second region 12F of the main surface 12B of the light guide plate 12 corresponds to the area provided with the infrared camera 11. The second region 12F of the main surface 12B is positioned and sized in accordance with the FOV of the infrared camera 11. The second region 12F of the main surface 12B is encompassed in a non-diffusing area overlapping with the through hole 13H of the diffusion plate 13. The diffusion plate 13 may further have through holes like the through hole 13H in the portions overlapping with the positions of the infrared sources 22. In this case, the main surface 12B of the light guide plate 12 includes a light-distribution control structure like the light-distribution control patterns 32 in FIG. 2, in the portions overlapping with the infrared sources 22, for example. These through holes and the portions are preferably positioned and sized in accordance with the ranges of infrared radiation from the infrared sources 22.

The reflective layers 31 include white reflectors 31A. The white reflectors 31A have a structure capable of disrupting the total reflection conditions of visible light propagating within the light guide plate 12 and thus allowing the light to be output from the light guide plate 12. For example, the white reflectors 31A are yielded by applying white coating into dots. The reflective layers 31 also include infrared absorbers 31B provided for the respective white reflectors 31A. The infrared absorbers 31B are yielded by applying black coating over the white reflectors 31A on the main surface 12B of the light guide plate 12. That is, the reflective layers 31 include a combination of the white reflectors 31A and the infrared absorbers 31B yielded by stacking the infrared absorbers 31B over the white reflectors 31A. The reflective layers 31 that combine the white reflectors 31A and the infrared absorbers 31B enable partial reflection of the visible light propagating within the light guide plate 12 toward the main surface 12A, and absorption of infrared rays emitted from the infrared sources 22 located outside the light guide plate 12 into the main surface 12B.

The light-distribution control patterns 32 are grooves defined by linear recesses on the main surface 12B of the light guide plate 12. The grooves of the light-distribution control patterns 32 each have a substantially triangular cross section. The grooves of the light-distribution control patterns 32 are produced by etching after resist coating, sandblasting, laser machining, nanoimprinting, cutting, grinding, or any other physical or chemical procedure.

The grooves of the light-distribution control patterns 32 accommodate unit reflectors 32A disposed on the respective inner side surfaces. The unit reflectors 32A are light reflectors coated or filled inside the grooves. The unit reflectors 32A may be thin films made of a highly reflective metal, such as silver (Ag) or aluminum (Al), for example. The unit reflectors 32A may be made of the same coating as that of the white reflectors 31A of the reflective layers 31.

The light-distribution control patterns 32 are further provided with unit absorbers 32B in association with the respective unit reflectors 32A. The unit absorbers 32B are yielded by applying black coating over the unit reflectors 32A on the main surface 12B of the light guide plate 12. The unit absorbers 32B may be made of the same infrared absorbing material as that of the infrared absorbers 31B. The unit absorbers 32B may also be made of an infrared absorbing material different from that of the infrared absorbers 31B.

The unit absorbers 32B of the light-distribution control patterns 32 are disposed within or on the outer surfaces of the unit reflectors 32A disposed in the respective grooves. The light-distribution control patterns 32 include a combination of the unit reflectors 32A and the unit absorbers 32B yielded by filling or stacking the unit absorbers 32B within or onto the unit reflectors 32A. The second region 12F of the main surface 12B of the light guide plate 12 provided with the light-distribution control patterns 32 causes the unit reflectors 32A of the light-distribution control patterns 32 to reflect at least part of the visible light propagating within the light guide plate 12 toward the main surface 12A, and causes the unit absorbers 32B of the light-distribution control patterns 32 to absorb at least part of the infrared rays emitted from the infrared sources 22 located outside the light guide plate 12 into the main surface 12B.

The main surface 12B of the light guide plate 12 has the second region 12F provided with the light-distribution control patterns 32 that combine the unit reflectors 32A and the unit absorbers 32B. The second region 12F of the main surface 12B of the light guide plate 12 causes the unit reflectors 32A of the light-distribution control patterns 32 to change the direction of light distribution of visible light propagating within the light guide plate 12. The second region 12F of the main surface 12B of the light guide plate 12 also causes the unit absorbers 32B of the light-distribution control patterns 32 to absorb infrared rays from the infrared sources 22 located outside the light guide plate 12. Furthermore, the second region 12F of the main surface 12B of the light guide plate 12 can transmit at least part of the infrared rays propagating, within the light guide plate 12, from the main surface 12A to the main surface 12B. The infrared rays output from the second region 12F of the main surface 12B of the light guide plate 12 to the −Z side are input into the infrared camera 11 located outside the light guide plate 12. The unit reflectors 32A are disposed on the respective inner side surfaces of the light-distribution control patterns 32 defined by linear recesses in the second region 12F of the main surface 12B of the light guide plate 12. The unit absorbers 32B are disposed within or on the outer surfaces of the respective unit reflectors 32A of the light-distribution control patterns 32.

The infrared camera 11 and the infrared sources 22 are disposed behind the light guide plate 12 or on its −Z side. This structure accompanied with the through hole 13H of the diffusion plate 13 enables the infrared rays entering from the +Z-side outside the light-emitting surface to be introduced into the infrared camera 11. The infrared rays emitted from the infrared sources 22 are incident to the main surface 12B of the light guide plate 12. At least part of the infrared rays incident to the main surface 12B of the light guide plate 12 enters the light guide plate 12, propagates from the main surface 12B to the main surface 12A, and then exits through the main surface 12A to the +Z side. The infrared rays output from the main surface 12A of the light guide plate 12 pass through the diffusion plate 13 and the transmissive portions of the liquid crystal panel 14, and are output to the +Z-side outside the light-emitting surface. The infrared rays output from the light-emitting surface of the liquid crystal display device 10 thus reach the imaging subject, such as the driver of the automobile.

The infrared rays reflected by the imaging subject at least partially return to the light-emitting surface of the liquid crystal display device 10. The infrared rays returning to the liquid crystal display device 10 propagate from the +Z-side outside the light-emitting surface through the transmissive portions of the liquid crystal panel 14 and the through hole 13H of the diffusion plate 13. The infrared rays after passing through the through hole 13H enter the light guide plate 12 through the main surface 12A thereof, and propagate from the main surface 12A to the main surface 12B. The infrared rays propagating within the light guide plate 12 to the main surface 12B are at least partially output through the second region 12F of the main surface 12B to the −Z side. The infrared rays propagating, within the light guide plate 12, from the main surface 12A to the main surface 12B allow the infrared camera 11 to capture images. The infrared rays to be input to the infrared camera 11 pass through the subregions, provided with no light-distribution control patterns 32, of the second region 12F of the main surface 12B of the light guide plate 12. The infrared rays after passing through the through hole 13H of the diffusion plate 13 are input into the infrared camera 11 and thus prevent blurring of camera images to be generated by the infrared camera 11.

The light source unit 25 including the light-emitting elements 21 is disposed on the right or +X side of the light guide plate 12 illustrated in FIG. 1. The visible light emitted from the individual light-emitting elements 21 of the light source unit 25 propagates in the left or −X direction, and thus enters the light guide plate 12 through the end face 12C thereof. The visible light after entering through the end face 12C of the light guide plate 12 propagates within the light guide plate 12 from the right or +X side to the left or −X side, while being repetitively totally reflected. The visible light propagating within the light guide plate 12 while being totally reflected is partially diffused or reflected by the reflective layers 31 or the light-distribution control patterns 32 on the surface of the light guide plate 12 and thus has the bent optical axis. Some part of such visible light fails to satisfy the total reflection conditions required for propagation within the light guide plate 12. The visible light failing to satisfy the total reflection conditions is output through the main surface 12A of the light guide plate 12 to the side adjacent to the liquid crystal panel 14. The reflective layers 31 and the light-distribution control patterns 32 on the main surface 12B of the light guide plate 12 can thus control the direction of light distribution by means of reflection of visible light. The visible light arriving at the end face 12D of the light guide plate 12 may be reflected by the side-surface reflective tape.

The first region 12E of the main surface 12B of the light guide plate 12 causes the white reflectors 31A of the reflective layers 31 to reflect visible light toward the main surface 12A. The second region 12F of the main surface 12B of the light guide plate 12 causes the unit reflectors 32A of the light-distribution control patterns 32 to reflect visible light toward the main surface 12A. The reflection of visible light by the unit reflectors 32A of the light-distribution control patterns 32 maintains sufficient luminance in the area overlapping with the infrared camera 11, thereby ensuring sufficient display visibility of the liquid crystal panel 14.

In the main surface 12B of the light guide plate 12, the subregions of the first region 12E provided with no reflective layers 31 and the subregions of the second region 12F provided with no light-distribution control patterns 32 can transmit infrared rays. The first region 12E of the main surface 12B of the light guide plate 12 causes the infrared absorbers 31B of the reflective layers 31 to absorb infrared rays, and thus prevents the white reflectors 31A from reflecting the infrared rays emitted from the infrared sources 22. The second region 12F of the main surface 12B of the light guide plate 12 causes the unit absorbers 32B of the light-distribution control patterns 32 to absorb infrared rays, and thus prevents the unit reflectors 32A from reflecting the infrared rays emitted from the infrared sources 22. The infrared absorbers 31B and the unit absorbers 32B can thus inhibit the infrared rays reflected by the white reflectors 31A and the unit reflectors 32A from reaching the infrared camera 11 and causing noise in camera images.

The liquid crystal display device 10 according to the embodiment includes the light-distribution control patterns 32 that combine the unit reflectors 32A and the unit absorbers 32B on the main surface 12B of the light guide plate 12. The unit reflectors 32A of the light-distribution control patterns 32 can reflect at least part of the visible light propagating within the light guide plate 12 toward the main surface 12A. The unit absorbers 32B of the light-distribution control patterns 32 can absorb infrared rays incident from the exterior of the light guide plate 12 to the main surface 12B. In addition, the second region 12F of the main surface 12B of the light guide plate 12 provided with the light-distribution control patterns 32 can transmit at least part of the infrared rays propagating, within the light guide plate 12, from the main surface 12A to the main surface 12B. This configuration enables the infrared camera 11, disposed behind the light guide plate 12 along with the infrared sources 22, to appropriately capture images while ensuring sufficient luminance.

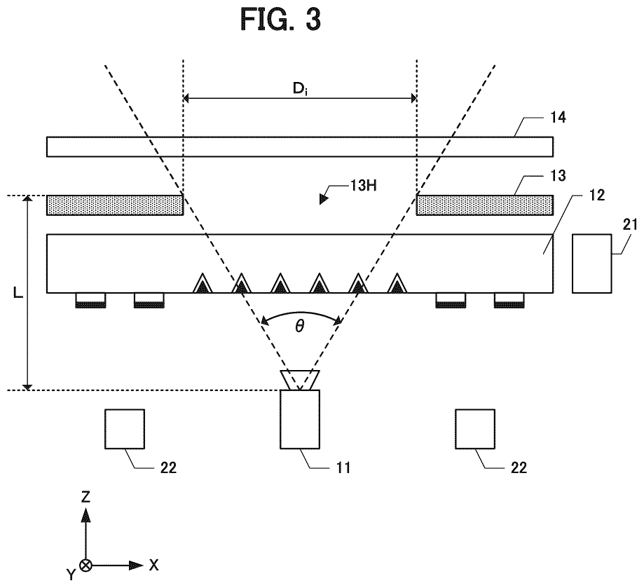

FIG. 3 is a sectional view for describing a diameter Di of the through hole 13H that is the opening extending through the diffusion plate 13. The distance L indicates the distance from the lens focal position of the infrared camera 11 to the diffusion plate 13. The angle θ corresponds to the FOV of the infrared camera 11. In this case, the diameter Di of the through hole 13H is defined by the expression below. The diameter Di of the through hole 13H may also be defined in view of a refractive index n of the light guide plate 12 that transmits infrared rays. The second region 12F of the main surface 12B of the light guide plate 12 provided with the light-distribution control patterns 32 may have the same size as the through hole 13H. The second region 12F may also be larger than the through hole 13H. The second region 12F is only required to be aligned to the through hole 13H in the assembled liquid crystal display device 10.

$${D}_{i} = 2 L tan \frac{θ}{2} \qquad Expression 1$$

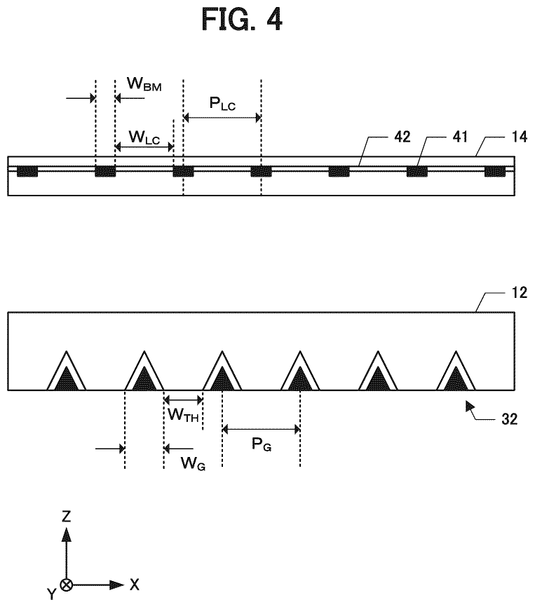

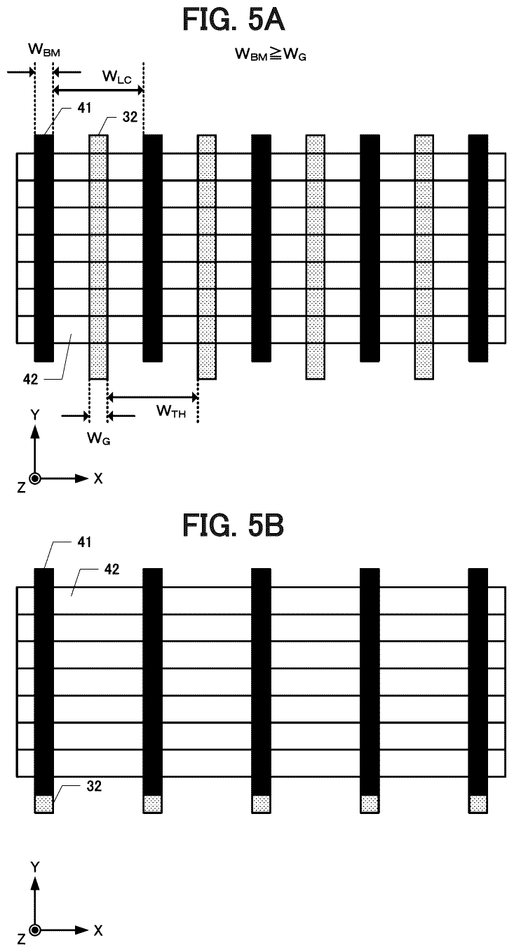

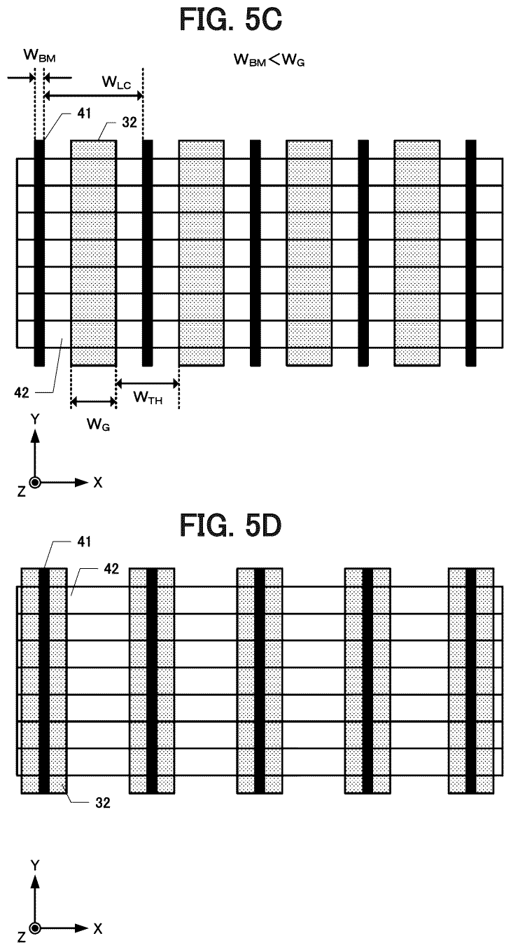

The following describes the dimensions including a pitch P_{G} of the light-distribution control patterns 32, with reference to FIGS. 4 and 5A to 5D. The light-distribution control patterns 32 are optical patterns that reflect visible light in the second region 12F of the main surface 12B of the light guide plate 12.

The light guide plate 12 illustrated in FIG. 4 has subregions provided with the light-distribution control patterns 32 each having an X-axis width W_{G}, to guide the visible light propagating within the light guide plate 12 to the exterior. The light-distribution control patterns 32 each have a linear shape extending in the Y-axis direction. In the exemplary configuration in FIG. 4, the light-distribution control patterns 32 extend in the direction forming an angle of 900 from the propagation direction of visible light from the light-emitting elements 21 within the light guide plate 12. The light-distribution control patterns 32 are apart from each other by an X-axis width W_{TH}. The second region 12F of the main surface 12B of the light guide plate 12 includes non-distributive subregions each having a width W_{T}H and not provided with the light-distribution control patterns 32. The light-distribution control patterns 32 in FIG. 4 are aligned at the pitch P_{G} in the X-axis direction.

For example, the liquid crystal panel 14 having a pixel pitch P_{LC} in the X-axis direction includes a black matrix 41 having an X-axis line width W_{BM}, and colored elements 42 having an X-axis width W_{LC}. The black matrix 41 and the colored elements 42 are disposed on the opposite substrate of the liquid crystal panel 14. The black matrix 41 is made of a material having low or substantially no visible light transmittance. The black matrix 41 is disposed over all or some of the TFTs, scanning wires, and signal wires on the TFT substrate of the liquid crystal panel 14.

The colored elements 42 include red, green, and blue color filters, and serve as color filters of the liquid crystal panel 14. The red, green, and blue color filters are each surrounded by the black matrix 41. In the color filters of the liquid crystal panel 14, the colored elements 42 are arranged in a stripe pattern. For example, the colored elements 42 having the same color in the color filters are aligned in the X-axis direction. The liquid crystal panel 14 has primary pixels arranged in a matrix and including red, green, and blue subpixels. The red subpixels emit red light. The green subpixels emit green light. The blue subpixels emit blue light. The red, green and, blue subpixels are collectively called subpixels. The red, green, and blue color filters in the colored elements 42 respectively correspond to the red, green and, blue subpixels. The colored elements 42 correspond to the transmissive portions of the liquid crystal panel 14 that transmit visible light.

The visible light reflected by the light-distribution control patterns 32 passes through the through hole 13H, and is thus not diffused by the diffusion plate 13. In other words, the visible light output through the second region 12F of the main surface 12B of the light guide plate 12 has nonuniform luminance. The transmissive portions of the liquid crystal panel 14, at the positions overlapping with the subregions having the width W_{TH} and not fed with visible light, cannot display images because of no incident light. To enable appropriate display by the liquid crystal panel 14, the structure must be designed to cause visible light reflected by the light-distribution control patterns 32 to pass through the transmissive portions associated with all the colored elements 42. The light-distribution control patterns 32 are thus preferably aligned at the pitch P_{G} equal to or smaller than the pixel pitch P_{LC} of the liquid crystal panel 14.

In FIGS. 5A and 5B, the width W_{G} of each light-distribution control pattern 32 is designed to be equal to or smaller than the line width W_{BM} of the black matrix 41. In the example in FIG. 5A, none of the light-distribution control patterns 32 overlaps with the black matrix 41, so that the light guide plate 12 feeds visible light to the transmissive portions associated with the colored elements 42 in FIG. 5A. In contrast, in the example in FIG. 5B, the light-distribution control patterns 32 overlap with the black matrix 41 that blocks the visible light guided by the light-distribution control patterns 32, and thus cannot improve the display quality of the liquid crystal panel 14.

As the liquid crystal display device 10 achieves a higher resolution, the liquid crystal panel 14 tends to have a reduced pixel pitch P_{LC}. The light-distribution control patterns 32 in this configuration are thus prone to overlapping with the black matrix 41. To achieve the display visible in all directions, the width W_{G} of each light-distribution control pattern 32 must be larger than the line width W_{BM} of the black matrix 41.

In FIGS. 5C and 5D, the width W_{G} of each light-distribution control pattern 32 illustrated is larger than the line width W_{BM} of the black matrix 41. The light-distribution control patterns 32 in FIG. 5C do not overlap with the black matrix 41. In contrast, the light-distribution control patterns 32 in FIG. 5D overlap with the black matrix 41.

Any difference in the light intensities fed to the respective transmissive portions associated with the colored elements 42 of the liquid crystal panel 14 causes a luminance variation. When the light-distribution control patterns 32 overlap with the black matrix 41, at least part of the reflected visible light is blocked by the black matrix 41. The blocking of light by the black matrix 41 lowers the luminance, thereby causing moire in the display. If the display is evaluated by multiple viewers, the moire is distinctively recognized by the viewers in the case of a luminance variation of 8% or more. In contrast, the moire is scarcely recognized, or recognized at an ignorable level by the viewers in the case of a luminance variation of less than 5%.

The luminance variation depends on the ratio between the width W_{G} of each light-distribution control pattern 32 and the line width W_{BM} of the black matrix 41. The line width W_{BM} of the black matrix 41 is preferably less than 8% of the width W_{G} of each light-distribution control pattern 32, to alleviate the effects of moire in all directions. The line width W_{BM} of the black matrix 41 is more preferably less than 5% of the width W_{G} of each light-distribution control pattern 32, to prevent the effects of moire in all directions.

In the second region 12F of the main surface 12B of the light guide plate 12, the unit reflectors 32A of the light-distribution control patterns 32 reflect visible light and infrared rays. The black matrix 41 of the liquid crystal panel 14 blocks visible light and infrared rays. The infrared rays to be used in image capturing by the infrared camera 11 pass through the transmissive portions of the liquid crystal panel 14 and the diffusion plate 13 or the through hole 13H, and then enter the light guide plate 12 through the main surface 12A thereof. The infrared rays propagating within the light guide plate 12 pass through the subregions of the second region 12F of the main surface 12B of the light guide plate 12 provided with no light-distribution control patterns 32.

The light-distribution control patterns 32 and the black matrix 41 in FIG. 5C block more infrared rays than the light-distribution control patterns 32 and the black matrix 41 in FIG. 5D. To enable the infrared camera 11 to acquire infrared rays from any angle, the width W_{G} of each light-distribution control pattern 32 must be smaller than the width W_{LC} of each transmissive portion of the liquid crystal panel 14. Furthermore, to allow at least the half of the transmissive portions of the liquid crystal panel 14 to transmit infrared rays, the width W_{G} of each light-distribution control pattern 32 is preferably less than 50% of the width W_{LC} of each transmissive portion of the liquid crystal panel 14.

The width W_{LC} of each transmissive portion is equal to a result of subtracting the line width W_{BM} of the black matrix 41 from the pixel pitch P_{LC} of the liquid crystal panel 14. Accordingly, the width W_{G} of each light-distribution control pattern 32 must be smaller than the result of subtracting the line width W_{BM} of the black matrix 41 from the pixel pitch P_{LC} of the liquid crystal panel 14. Preferably, the width W_{G} of each light-distribution control pattern 32 is less than 50% of the result of subtracting the line width W_{BM} of the black matrix 41 from the pixel pitch P_{LC} of the liquid crystal panel 14. Within these conditions, the light-distribution control patterns 32 may be aligned at regular or irregular intervals in the second region 12F of the main surface 12B of the light guide plate 12. For example, the light-distribution control patterns 32 may be aligned, such that the interval between adjacent light-distribution control patterns 32 gradually extends from the center of the second region 12F in the X-axis direction, that is, the number per unit length in the X-axis direction decreases monotonously from the center of the second region 12F.

As described above, the liquid crystal display device 10 according to the embodiment includes the light-distribution control patterns 32 that combine the unit reflectors 32A and the unit absorbers 32B on the main surface 12B of the light guide plate 12. The light-distribution control patterns 32 are defined by linear recesses. The liquid crystal panel 14 displays images using visible light output from the light guide plate 12 and the diffusion plate 13. The light-distribution control patterns 32 in this case are aligned at the pitch P_{G} equal to the pixel pitch P_{L}C of the liquid crystal panel 14. The width W_{G} of each light-distribution control pattern 32 is larger than the line width W_{BM} of the black matrix 41 of the liquid crystal panel 14. In addition, the width W_{G} of each light-distribution control pattern 32 is less than 50% of the width W_{LC} of each transmissive portion of the liquid crystal panel 14. The line width W_{BM} of the black matrix 41 of the liquid crystal panel 14 is less than 8% of the width W_{G} of each light-distribution control pattern 32, and preferably less than 5% of the width W_{G} of each light-distribution control pattern 32. This configuration enables the liquid crystal display device 10 to appropriately display images on the liquid crystal panel 14 while ensuring sufficient luminance, and enables the infrared camera 11, disposed behind the light guide plate 12, to appropriately capture images.

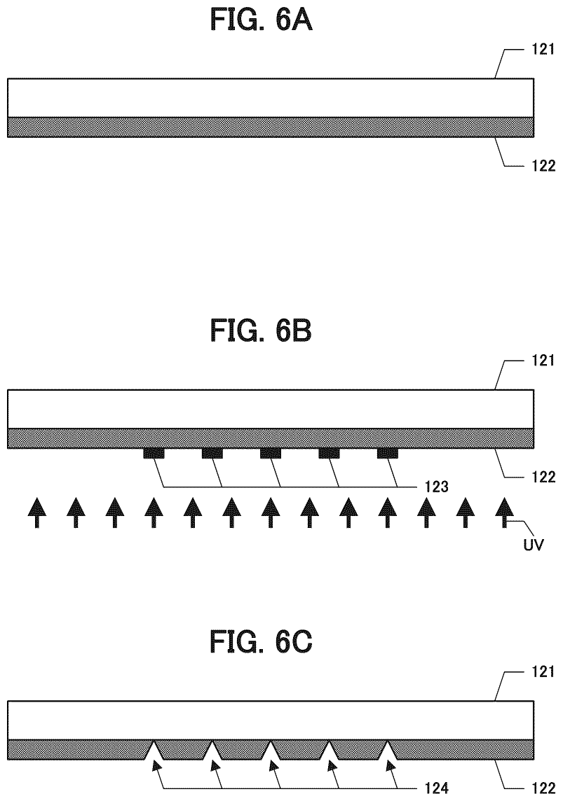

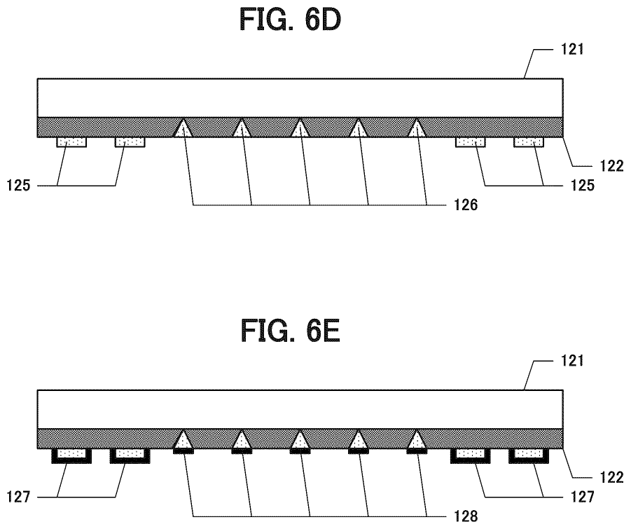

FIGS. 6A to 6E illustrate an exemplary process of fabricating the light guide plate 12. The light guide plate 12 in this example is made of an acrylic resin. FIG. 6A illustrates a first step of applying a UV-curing resin 122 to an acrylic plate 121. FIG. 6B illustrates a second step of placing a photomask 123 on the UV-curing resin 122, and irradiating the UV-curing resin 122 with ultraviolet light UV. The photomask 123 has masking patterns associated with the light-distribution control patterns 32. FIG. 6C illustrates a third step of removing the photomask 123 and the masked portion of the UV-curing resin 122 through washing. These steps provide the UV-curing resin 122 with linear grooves 124 to form the light-distribution control patterns 32.

FIG. 6D illustrates a fourth step of applying white reflectors 125 and 126. The white reflectors 125 correspond to the white reflectors 31A of the reflective layers 31. The white reflectors 126 correspond to the unit reflectors 32A of the light-distribution control patterns 32. FIG. 6E illustrates a fifth step of applying black absorbers 127 and 128. The black absorbers 127 correspond to the infrared absorbers 31B of the reflective layers 31. The black absorbers 128 correspond to the unit absorbers 32B of the light-distribution control patterns 32.

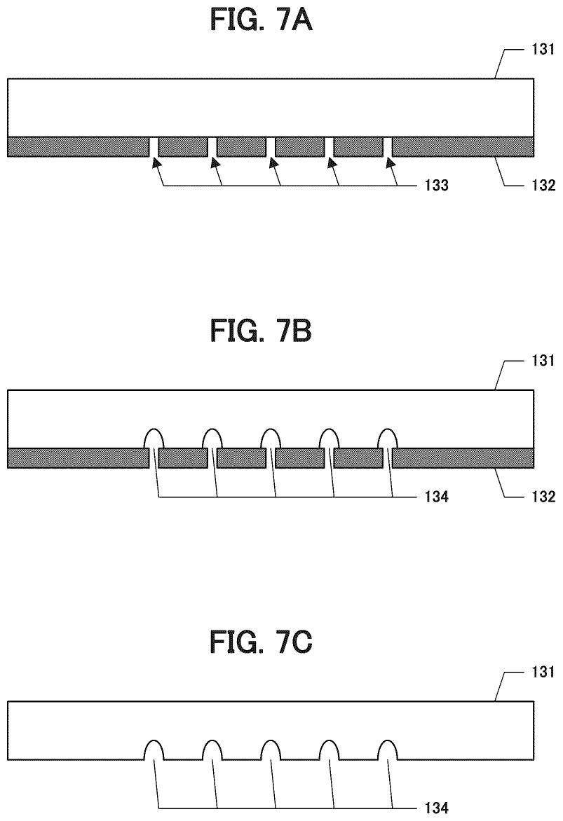

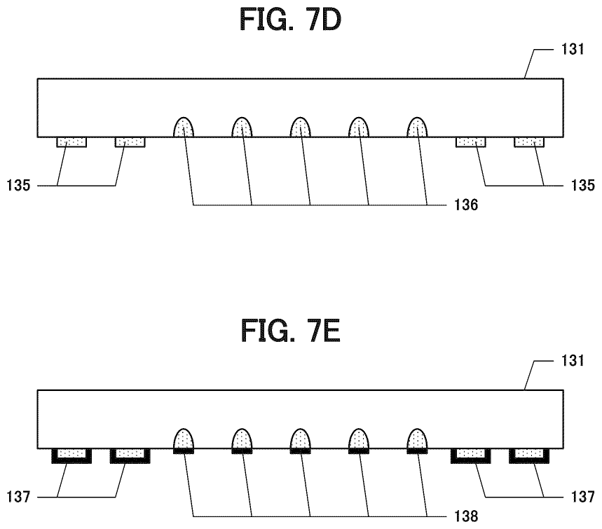

FIGS. 7A to 7E illustrate another exemplary process of fabricating the light guide plate 12. The light guide plate 12 in this example is made of glass. FIG. 7A illustrates a first step of partially removing a photoresist 132 applied to a glass substrate 131, for example, through washing. This step provides the photoresist 132 with opening patterns 133 associated with the light-distribution control patterns 32. FIG. 7B illustrates a second step of etching the glass substrate 131 through hydrofluoric acid treatment. The hydrofluoric acid treatment is an isotropic etching process, and expands to reach the contact surface between the glass substrate 131 and the photoresist 132. This step provides the glass substrate 131 with linear grooves 134 associated with the light-distribution control patterns 32. FIG. 7C illustrates a third step of peeling the photoresist 132.

FIG. 7D illustrates a fourth step of applying white reflectors 135 and 136. The white reflectors 135 correspond to the white reflectors 31A of the reflective layers 31. The white reflectors 136 correspond to the unit reflectors 32A of the light-distribution control patterns 32.

FIG. 7E illustrates a fifth step of applying black absorbers 137 and 138. The black absorbers 137 correspond to the infrared absorbers 31B of the reflective layers 31. The black absorbers 138 correspond to the unit absorbers 32B of the light-distribution control patterns 32.

The above-described processes both provide the main surface 12B of the light guide plate 12 with the reflective layers 31 serving as the first light-distribution control structure in the first region 12E, and the light-distribution control patterns 32 serving as the second light-distribution control structure in the second region 12F. The first and second light-distribution control structures each combine light reflectors and infrared absorbers on the main surface 12B of the light guide plate 12. In particular, the light-distribution control patterns 32 in the second region 12F enable the visible light to be output through the area overlapping with the through hole 13H of the diffusion plate 13. The second region 12F provided with the light-distribution control patterns 32 can cause the unit absorbers 32B to absorb part of the infrared rays incident from the exterior of the light guide plate 12 to the main surface 12B, and can transmit another part of the infrared rays. The second region 12F provided with the light-distribution control patterns 32 can also transmit at least part of the infrared rays propagating, within the light guide plate 12, from the main surface 12A to the main surface 12B. This configuration enables the liquid crystal display device 10 to appropriately display images on the liquid crystal panel 14 while ensuring sufficient luminance, and enables the infrared camera 11, disposed behind the light guide plate 12 along with the infrared sources 22, to appropriately capture images.

The infrared camera 11 exhibits no or substantially lower sensitivity to visible light than to infrared light. The infrared camera 11 may be provided with an optical filter in its incident segment that transmits only infrared rays and thus significantly reduces its sensitivity to visible light. The infrared camera 11 of the liquid crystal display device 10 can thus capture images during emission of visible light from the lighting unit 20, and thus ensure the visibility of camera images. In contrast, the image capturing by a visible light camera requires temporary and partial switching of the operation mode of the lighting unit 20 of the liquid crystal display device 10, from the on mode to the off mode. Unlike such a visible light camera, the infrared camera 11 can capture images and generate appropriate camera images, without switching the operation mode of the lighting unit 20 of the liquid crystal display device 10 from the on mode to the off mode. The liquid crystal display device 10 according to the present disclosure thus allows its lighting unit 20 to have a simpler circuit than a unit including a visible light camera, because of no need for the mode switching function.

The light guide plate 12 can cause the light-distribution control patterns 32 in the second region 12F of the main surface 12B to reflect visible light, and output the light through the region of the main surface 12A overlapping with the infrared camera 11 toward the viewer's or +Z side. The light-emitting elements 21, serving as visible light sources for the light guide plate 12, are disposed outside the end face 12C of the light guide plate 12, and thus eliminate the need for visible light sources around the infrared camera 11. This configuration can provide sufficiently intense visible light in the area overlapping with the infrared camera 11. The configuration including no visible light sources around the infrared camera 11 avoids any visual discomfort for viewers.

### Embodiment 2

The reflective layers 31 provided in the first region 12E of the main surface 12B of the light guide plate 12, may include a light reflective sheet 31C and an infrared absorption sheet 31D different from the light-distribution control structure, instead of the combination of the white reflectors 31A and the infrared absorbers 31B. Alternatively, the reflective layers 31 may include the light reflective sheet 31C in addition to the white reflectors 31A.

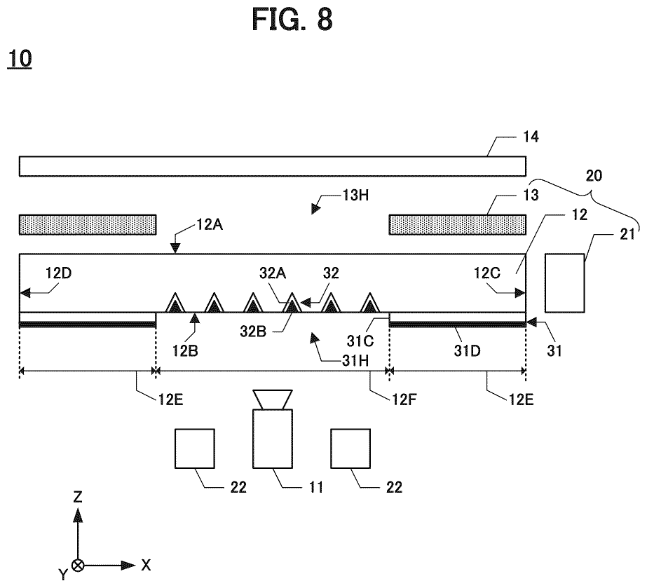

FIG. 8 illustrates an exemplary configuration of the liquid crystal display device 10 including the light reflective sheet 31C and the infrared absorption sheet 31D. The light reflective sheet 31C may cover the entire first region 12E. The light reflective sheet 31C reflects at least light having wavelengths in the visible light range. The infrared absorption sheet 31D may cover the entire first region 12E. The infrared absorption sheet 31D is required to absorb at least rays having wavelengths in the infrared range. The light reflective sheet 31C and the infrared absorption sheet 31D have a through hole 31H in the areas overlapping with the positions of the infrared camera 11 and the infrared sources 22. The through hole 31H of the light reflective sheet 31C and the infrared absorption sheet 31D enables transmission of the infrared rays emitted from the infrared sources 22 and the infrared rays to be input to the infrared camera 11.

The light reflective sheet 31C and the infrared absorption sheet 31D different from the light-distribution control structure are stacked in the first region 12E, not overlapping with the through hole 13H of the diffusion plate 13, of the main surface 12B of the light guide plate 12. The light reflective sheet 31C reflects all or most of the visible light in the first region 12E of the main surface 12B of the light guide plate 12, and thus improves the light use efficiency. The light reflective sheet 31C and the infrared absorption sheet 31D may be separate sheets or a single integrated sheet. The light reflective sheet 31C and the infrared absorption sheet 31D are not required to be bonded to the light guide plate 12 and may have a space therefrom. In this case, the main surface 12B of the light guide plate 12 requires some components, such as the combination of the white reflectors 31A and the infrared absorbers 31B illustrated in FIG. 2.

In FIG. 8, the light-distribution control patterns 32 serving as the light-distribution control structure are provided in the second region 12F of the main surface 12B of the light guide plate 12 overlapping with the through hole 13H of the diffusion plate 13, as in FIG. 2. The unit reflectors 32A are light reflectors disposed on the respective inner side surfaces of the light-distribution control patterns 32. The unit absorbers 32B are infrared absorbers disposed within or on the outer surfaces of the unit reflectors 32A.

The main surface 12B of the light guide plate 12 illustrated in FIG. 8 is provided with the light reflective sheet 31C and the infrared absorption sheet 31D different from the light-distribution control structure in the first region 12E. The main surface 12B of the light guide plate 12 is further provided with the light-distribution control patterns 32 in the second region 12F overlapping with the through hole 13H of the diffusion plate 13. The light-distribution control patterns 32 include the combination of the unit reflectors 32A and the unit absorbers 32B. The light-distribution control patterns 32 enable output of visible light through the area overlapping with the through hole 13H of the diffusion plate 13. In addition, the second region 12F provided with the light-distribution control patterns 32 can cause the unit absorbers 32B to absorb part of the infrared rays incident from the exterior of the light guide plate 12 to the main surface 12B, and can transmit another part of the infrared rays. The second region 12F provided with the light-distribution control patterns 32 can also transmit at least part of the infrared rays propagating, within the light guide plate 12, from the main surface 12A to the main surface 12B. This configuration enables the liquid crystal display device 10 to appropriately display images on the liquid crystal panel 14 while ensuring sufficient luminance, and enables the infrared camera 11, disposed behind the light guide plate 12 along with the infrared sources 22, to appropriately capture images.

### Embodiment 3

The light-distribution control patterns 32 provided in the second region 12F of the main surface 12B of the light guide plate 12 may include the unit reflectors 32A made of a light diffusing material. The reflective layers 31 provided in the first region 12E of the main surface 12B of the light guide plate 12 may include the infrared absorption sheet 31D that covers the white reflectors 31A.

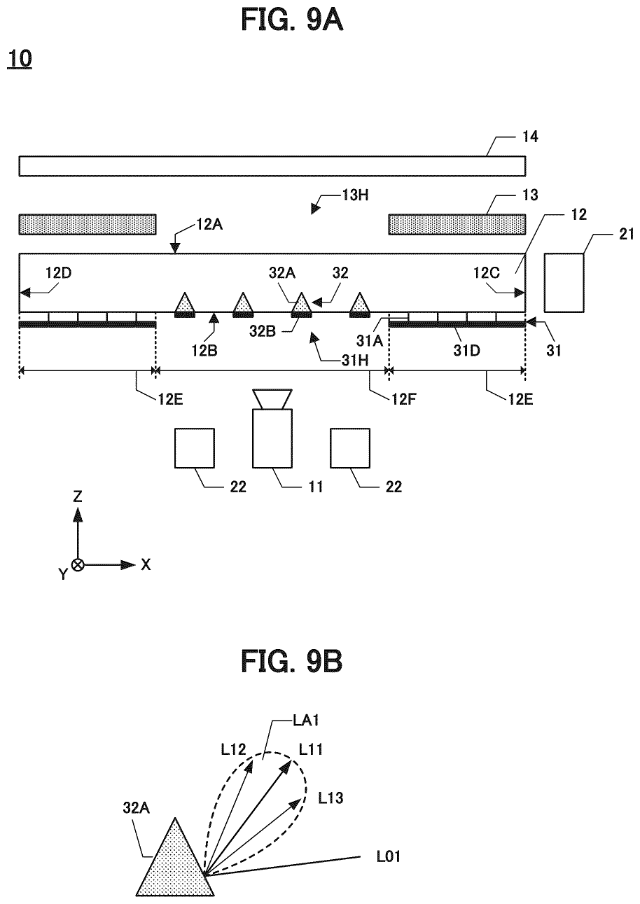

FIG. 9A illustrates an exemplary configuration of the liquid crystal display device 10 provided with the unit reflectors 32A having light diffusion properties and the infrared absorption sheet 31D. The infrared absorption sheet 31D may cover the entire first region 12E. The infrared absorption sheet 31D has a through hole 31H in the area overlapping with the positions of the infrared camera 11 and the infrared sources 22. The through hole 31H of the infrared absorption sheet 31D enables transmission of the infrared rays emitted from the infrared sources 22 and the infrared rays to be input to the infrared camera 11. The infrared absorption sheet 31D that covers the white reflectors 31A is stacked in the first region 12E of the main surface 12B of the light guide plate 12 not overlapping with the through hole 13H of the diffusion plate 13.

FIG. 9A illustrates the light-distribution control patterns 32 including the unit reflectors 32A having light reflectivity and light diffusion properties. The unit reflectors 32A may be fabricated by kneading a diffuser, such as magnesium dioxide (MgO₂) for diffusively reflecting visible light, or using a light diffusing ink, for example. The unit absorbers 32B are infrared absorbers stacked on the respective unit reflectors 32A so as to cover their outer surfaces.

FIG. 9B illustrates exemplary diffuse reflection of visible light on the unit reflector 32A in the embodiment. When visible light L01 propagating within the light guide plate 12 is incident to a reflective surface of the unit reflector 32A, the unit reflector 32A diffusively reflects the visible light L01 in a range LA1 encompassing reflected light L11 to L13. The unit reflector 32A diffusively reflects the visible light propagating within the light guide plate 12, and thus changes the direction of light distribution of the visible light. The unit reflectors 32A of the light-distribution control patterns 32 in Embodiment 3 can diffusively reflect a sufficient amount of visible light even if the light-distribution control patterns 32 are fewer than those in Embodiment 1. This configuration can improve the luminance of visible light to be output from the lighting unit 20 in the area overlapping with the infrared camera 11 and the infrared sources 22.

The main surface 12B of the light guide plate 12 illustrated in FIG. 9A is provided with the reflective layers 31 that combine the white reflectors 31A and the infrared absorption sheet 31D in the first region 12E. The main surface 12B of the light guide plate 12 is also provided with the light-distribution control patterns 32 in the second region 12F overlapping with the through hole 13H of the diffusion plate 13. The light-distribution control patterns 32 include the combination of the unit reflectors 32A having light diffusion properties and the unit absorbers 32B. The light-distribution control patterns 32 enable output of visible light through the area overlapping with the through hole 13H of the diffusion plate 13. In addition, the second region 12F provided with the light-distribution control patterns 32 can cause the unit absorbers 32B to absorb part of the infrared rays incident from the exterior of the light guide plate 12 to the main surface 12B, and can transmit another part of the infrared rays. The second region 12F provided with the light-distribution control patterns 32 can also transmit at least part of the infrared rays propagating, within the light guide plate 12, from the main surface 12A to the main surface 12B. This configuration enables the liquid crystal display device 10 to appropriately display images on the liquid crystal panel 14 while ensuring sufficient luminance, and enables the infrared camera 11, disposed behind the light guide plate 12 along with the infrared sources 22, to appropriately capture images.

### Embodiment 4

The light-distribution control patterns 32 provided in the second region 12F of the main surface 12B of the light guide plate 12 may extend in a direction not parallel to but forming a predetermined angle from the black matrix 41 of the liquid crystal panel 14. In this modification, the width W_{G} of each light-distribution control pattern 32 may be smaller than the line width W_{BM} of the black matrix 41. The width W_{G} of each light-distribution control pattern 32 may also be larger than the line width W_{BM} of the black matrix 41, as in Embodiment 1.

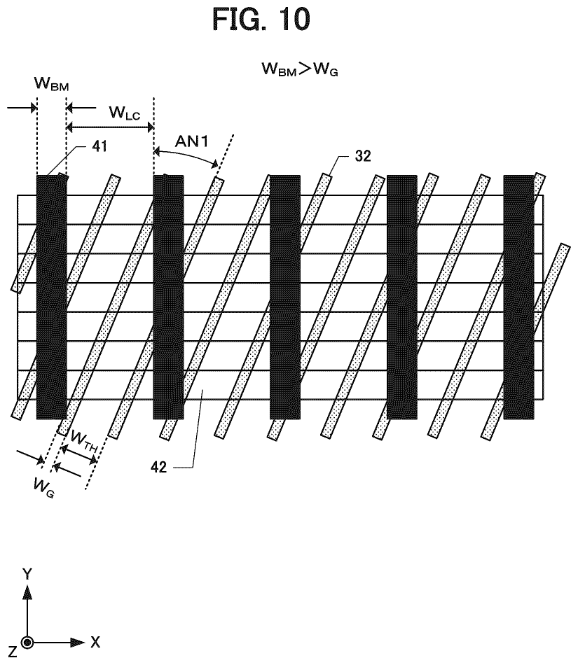

FIG. 10 illustrates an exemplary configuration of the light-distribution control patterns 32 having a predetermined inclination angle AN1. The width W_{G} of each light-distribution control pattern 32 illustrated in FIG. 10 is smaller than the line width W_{BM} of the black matrix 41. The predetermined inclination angle AN1 indicates an angle of the light-distribution control patterns 32 relative to the Y-axis direction in which the black matrix 41 of the liquid crystal panel 14 extends. The predetermined inclination angle AN1 is typically 22.5°, and may also be any angle of 15° or larger and 450 or smaller.

In an exemplary case where the light-distribution control patterns 32 are aligned in parallel to the black matrix 41 as illustrated in FIGS. 5A to 5D, the light-distribution control patterns 32 may partially overlap with the black matrix 41. The overlapping portions between the light-distribution control patterns 32 and the black matrix 41 result in reduced luminance of visible light output from the liquid crystal display device 10. For example, the light-distribution control patterns 32, aligned at a pitch P_{G} in the X-axis direction different from the pixel pitch P_{LC} of the liquid crystal panel 14, have a spatial frequency different from the black matrix 41. Such a difference in spatial frequency results in moire that degrades the display quality of the liquid crystal panel 14.

The light-distribution control patterns 32 of the liquid crystal display device 10 according to the embodiment are aligned at the predetermined inclination angle AN1 from the black matrix 41 of the liquid crystal panel 14. This structure increases the interference frequency in the relationship between the spatial frequency of the light-distribution control patterns 32 and the spatial frequency of the black matrix 41. Such an increased interference frequency results in ignorable moire in the image displayed on the liquid crystal panel 14, thereby preventing degradation of the display quality. The liquid crystal display device 10 according to the embodiment thus enables the liquid crystal panel 14 to appropriately display images, and enables the infrared camera 11, disposed behind the light guide plate 12 along with the infrared sources 22, to appropriately capture images.

### Embodiment 5

The main surface 12B of the light guide plate 12 may be provided with a single integrated light-distribution control pattern, instead of the light-distribution control patterns 32 provided in the second region 12F. The single light-distribution control pattern may have a web structure containing multiple connecting points and multiple line segments, for example. In this modification, one of the line segments is connected to another line segment at any of the connecting points. The single light-distribution control pattern may have a shape depicted by randomly displacing connecting points in a predetermined basic geometry.

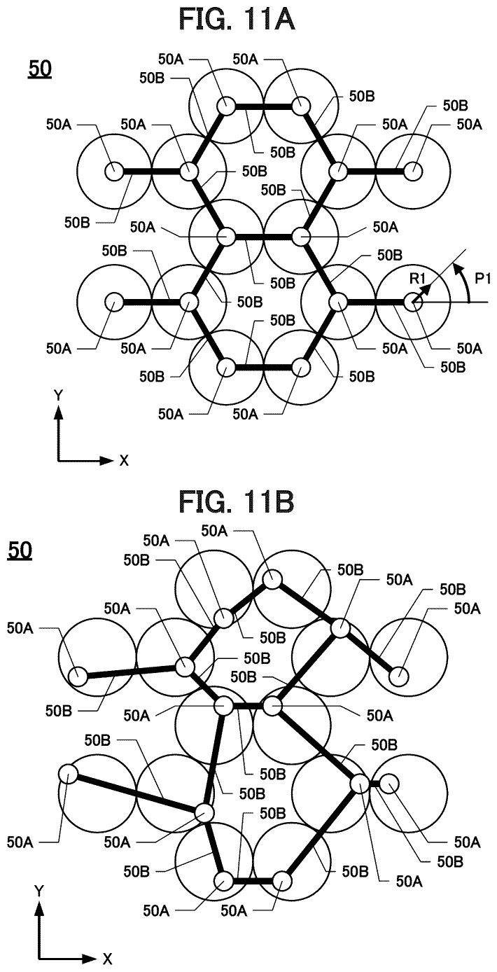

The following describes an exemplary process of determining the shape of a light-distribution control pattern 50, with reference to FIGS. 11A and 11B. FIG. 11A illustrates a basic geometry of the light-distribution control pattern 50. In FIG. 11A, the light-distribution control pattern 50 contains connecting points 50A and line segments 50B regularly arranged in a honeycomb structure. The basic geometry of the light-distribution control pattern 50 may be any predefined geometry representing a regular arrangement other than the honeycomb structure. Examples of the geometry include a lattice structure and a mesh structure.

This basic geometry of the light-distribution control pattern 50 is provided with polar coordinate systems each using a connecting point 50A as the origin. For each connecting point 50A, the radius R1 and the angle P1 relative to the X-axis direction are randomly determined in the polar coordinate system. The radius R1 has a length equal to or larger than 0 and smaller than half the length of the line segment 50B. The angle P1 is equal to or larger than 0° and smaller than 360°. The radius R1 and the angle P1 may be randomly determined by using random numbers generated by a specific random-number generating circuit. The connecting points 50A are then displaced to the respective positions determined as described above. FIG. 11B illustrates an example of the light-distribution control pattern 50 determined by displacing the connecting points 50A.

The original position of each connecting point 50A in the basic geometry of the light-distribution control pattern 50 is used as a reference point associated with the origin of the polar coordinate system. The connecting point 50A in the actual light-distribution control pattern 50 is located at the position defined by the randomly determined radius R1 and angle P1 relative to this reference point in the polar coordinate system. The actual light-distribution control pattern 50 has a shape corresponding to the line segments 50B that link the connecting points 50A at the positions defined by the radiuses R1 and the angles P1. The light-distribution control pattern 50 in the embodiment is a single groove defined by a recess having this shape corresponding to these line segments 50B.

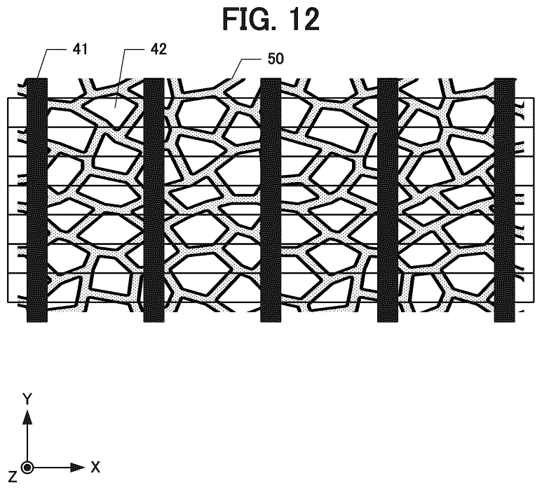

FIG. 12 illustrates an exemplary configuration of the light-distribution control pattern 50, as well as the black matrix 41 and the colored elements 42 of the liquid crystal panel 14. The light-distribution control pattern 50 in the embodiment may include a reflector made of the same material as that of the unit reflectors 32A in the above-described embodiments, and an absorber made of the same material as that of the unit absorbers 32B in the above-described embodiments. The reflector of the light-distribution control pattern 50 is disposed on the inner side surface of the groove. The reflector is applied or filled within the groove of the light-distribution control pattern 50. The absorber of the light-distribution control pattern 50 is provided for the corresponding reflector. The absorber is applied to cover the reflector in the light-distribution control pattern 50.

The absorber of the light-distribution control pattern 50 is disposed within or on the outer surface of the reflector within the groove. The light-distribution control pattern 50 includes the combination of the reflector and the absorber yielded by filling or stacking the absorber within or onto the reflector. The second region 12F of the main surface 12B of the light guide plate 12 provided with the light-distribution control pattern 50 can cause the reflector of the light-distribution control pattern 50 to reflect at least part of the visible light propagating within the light guide plate 12 toward the main surface 12A, and can cause the absorber of the light-distribution control pattern 50 to absorb at least part of the infrared rays emitted from the infrared sources 22 located outside the light guide plate 12 into the main surface 12B. In addition, the second region 12F of the main surface 12B of the light guide plate 12 provided with the light-distribution control pattern 50 can transmit at least part of the infrared rays propagating within the light guide plate 12 from the main surface 12A to the main surface 12B.

The light-distribution control pattern 50 in the embodiment may be divided into multiple pattern segments. For example, some of the connecting points 50A of the light-distribution control pattern 50 are disconnected from other adjacent connecting points 50A by partial removal of the line segments 50B. That is, the light-distribution control pattern 50 in the embodiment may have grooves defined by recesses having the shape corresponding to the line segments 50B that link the connecting points 50A at the positions, each of which is defined by the radius and the angle randomly determined in a polar coordinate system having the origin at a reference point in the original basic geometry.

As described above, the second region 12F of the main surface 12B of the light guide plate 12 overlapping with the through hole 13H of the diffusion plate 13 is provided with the light-distribution control pattern 50. This light-distribution control pattern 50 includes at least one groove defined by at least one recess having the shape corresponding to the line segments 50B that link the connecting points 50A at the positions, each of which is defined by the radius and the angle randomly determined in a polar coordinate system having the origin at a reference point in the original basic geometry. In addition, the light-distribution control pattern 50 includes a combination of the reflector like the unit reflectors 32A and the absorber like the unit absorbers 32B. This light-distribution control pattern 50 enables output of visible light and absorption and transmission of infrared rays through the area overlapping with the through hole 13H of the diffusion plate 13, like the light-distribution control patterns 32. This configuration enables the liquid crystal display device 10 to appropriately display images on the liquid crystal panel 14 while ensuring sufficient luminance, and enables the infrared camera 11, disposed behind the light guide plate 12 along with the infrared sources 22, to appropriately capture images.

### Embodiment 6

The main surface 12B of the light guide plate 12 may be provided with dot patterns, instead of the linear light-distribution control patterns 32 provided in the second region 12F. The dot patterns are minute reflective components having any structure or member capable of reflecting visible light. Examples of such components include protrusions, recesses, steps, projections, white coatings, thin metal films, and combinations of all or some of these components. The dot patterns may be produced by printing, such as inkjet printing, photolithography, etching, laser machining, blasting, or any other physical or chemical procedure, for example. The dot patterns may be disposed inside the light guide plate 12, or added to the exterior of the light guide plate 12.

The positions of the dot patterns in the embodiment may be determined, like the positions of the connecting points 50A in Embodiment 5. More specifically, the basic geometry of the dot patterns is provided with polar coordinate systems each using a reference point as the origin. For each dot, the radius and the angle in the polar coordinate system are randomly determined. The dots in the actual dot patterns are located at the positions determined as described above. The actual dot patterns include multiple dots at the positions defined by the radiuses and angles in the polar coordinate systems having their origins at the reference points. The dot patterns in the embodiment are recesses defined by punctate depressions associated with the dots.

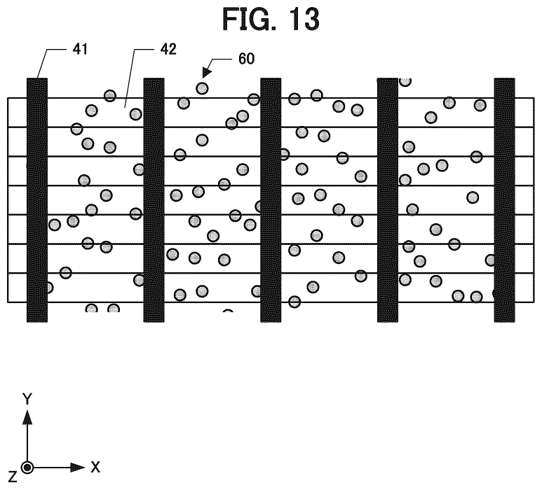

FIG. 13 illustrates an exemplary configuration of the dot patterns 60, as well as the black matrix 41 and the colored elements 42 of the liquid crystal panel 14. The dot patterns 60 in the embodiment may include reflectors made of the same material as that of the unit reflectors 32A in the above-described embodiments, and absorbers made of the same material as that of the unit absorbers 32B in the above-described embodiments. The reflectors of the dot patterns 60 are disposed on the inner side surfaces of the recesses. The reflectors are applied or filled within the recesses of the dot patterns 60. The absorbers of the dot patterns 60 are provided for the respective reflectors. The absorbers are applied to cover the reflectors in the dot patterns 60.

The absorbers of the dot patterns 60 are disposed within or on the outer surfaces of the reflectors inside the recesses. The dot patterns 60 include the combination of the reflectors and the absorbers yielded by filling or stacking the absorbers within or onto the reflectors. The second region 12F of the main surface 12B of the light guide plate 12 provided with the dot patterns 60 causes the reflectors of the dot patterns 60 to reflect at least part of the visible light propagating within the light guide plate 12 toward the main surface 12A, and causes the absorbers of the dot patterns 60 to absorb at least part of the infrared rays emitted from the infrared sources 22 located outside the light guide plate 12 into the main surface 12B. In addition, the second region 12F of the main surface 12B of the light guide plate 12 provided with the dot patterns 60 can transmit at least part of the infrared rays propagating within the light guide plate 12 from the main surface 12A to the main surface 12B.

As described above, the main surface 12B of the light guide plate 12 is provided with the dot patterns 60 in the second region 12F corresponding to the through hole 13H of the diffusion plate 13. These dot patterns 60 include recesses associated with dots at the positions, each of which is defined by the radius and the angle randomly determined in a polar coordinate system having the origin at a reference point in the original basic geometry. In addition, the dot patterns 60 include the combination of the reflectors like the unit reflectors 32A and the absorbers like the unit absorbers 32B. The dot patterns 60 enable output of visible light and absorption and transmission of infrared rays through the area overlapping with the through hole 13H of the diffusion plate 13, like the light-distribution control patterns 32. This configuration enables the liquid crystal display device 10 to appropriately display images on the liquid crystal panel 14 while ensuring sufficient luminance, and enables the infrared camera 11, disposed behind the light guide plate 12 along with the infrared sources 22, to appropriately capture images.

### Other Modifications

The structure including the reflective layers 31 is a mere example of the visible-light outputting structure provided in the first region 12E of the main surface 12B of the light guide plate 12. Other examples of the structure include a luminous structure with light-emitting elements, a photorefractive structure with a prism, a light reflective structure with a mirror, a light convergence structure with a lens, a light diffusing structure with light diffusing elements, combinations of all or part of these structures, or any other visible-light outputting structures. A specific example of the luminous structure with light-emitting elements is a structure with a direct-lit backlight. In these structures, the component that provides visible light to be output through a first region of the light-emitting surface of the lighting unit 20, corresponding to the first region 12E of the main surface 12B of the light guide plate 12, is an example of a first illuminator. The light guide plate 12 overlaps with the first illuminator in the direction of the light-emitting surface in the lighting unit 20. The light guide plate 12 is an example of a second illuminator to provide visible light to be output through a second region of the light-emitting surface that is at least partially different from the first region and corresponds to the second region 12F of the main surface 12B.

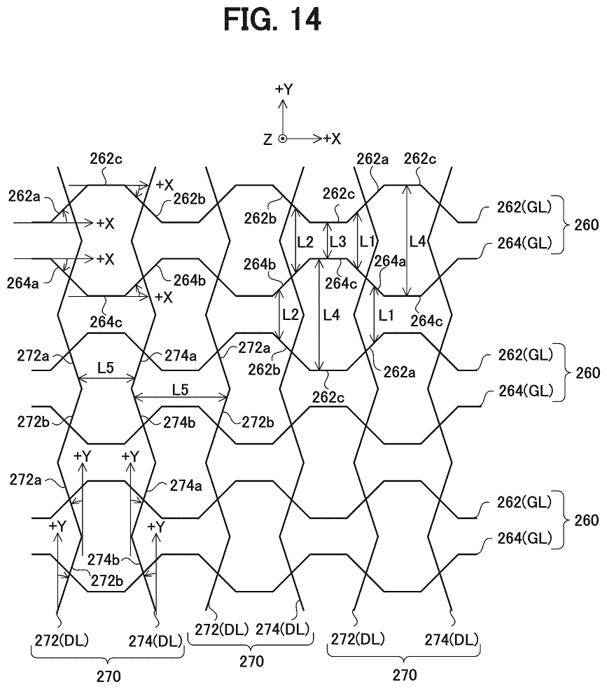

In the display unit of the liquid crystal display device 10, the liquid crystal panel 14 may be replaced with multiple liquid crystal display panels. In this modification, at least one of the liquid crystal display panels may have light-blocking shading patterns. The shading patterns are repetitively arranged. FIG. 14 illustrates shading patterns that include first shading patterns 260 made of scanning wires GL, and second shading patterns 270 made of signal wires DL. The scanning wires GL of the first shading patterns 260 extend in the X-axis direction and are apart from each other in the Y-axis direction. Each pair of scanning wires GL extend in the X-axis direction and form one of the light-blocking first shading patterns 260. The first shading patterns 260 are repetitively arranged in the Y-axis direction. The light-blocking properties indicate a function of blocking at least part of the light incident from the lighting unit 20. The X-axis direction corresponds to a predetermined direction in the first shading patterns 260. The signal wires DL of the second shading patterns 270 extend in the Y-axis direction and are apart from each other in the X-axis direction. Each pair of signal wires DL extend in the Y-axis direction and form one of the light-blocking second shading patterns 270. The second shading patterns 270 are repetitively arranged in the X-axis direction. The Y-axis direction corresponds to a predetermined direction in the second shading patterns 270.

In this modification, one of each pair of scanning wires GL adjacent to each other is a first shading wire 262. The first shading wire 262 contains first inclined segments 262a, second inclined segments 262b, and first flat segments 262c. The first inclined segments 262a are acutely inclined in the counterclockwise direction relative to the +X direction. The second inclined segments 262b are acutely inclined in the clockwise direction, opposite to the first inclined segments 262a, relative to the +X direction. The first flat segments 262c extend in parallel to the X-axis direction. The first flat segments 262c are each connected to the first inclined segment 262a and the second inclined segment 262b. The other of the pair of scanning wires GL adjacent to each other is a second shading wire 264. The second shading wire 264 contains third inclined segments 264a, fourth inclined segments 264b, and second flat segments 264c. The second shading wire 264 is symmetrical with the first shading wire 262 about the X-axis direction. The third inclined segments 264a are opposed to the first inclined segments 262a of the first shading wire 262 and acutely inclined in the clockwise direction relative to the +X direction. The fourth inclined segments 264b are opposed to the second inclined segments 262b of the first shading wire 262, and acutely inclined in the counterclockwise direction, opposite to the third inclined segments 264a, relative to the +X direction. The second flat segments 264c extend in parallel to the X-axis direction. The second flat segments 264c are opposed to the first flat segments 262c of the first shading wire 262. The second flat segments 264c are each connected to the third inclined segment 264a and the fourth inclined segment 264b.

The first shading wire 262 and the second shading wire 264 have a continuously varying distance L1 between the first inclined segments 262a of the first shading wire 262 and the third inclined segments 264a of the second shading wire 264. The first shading wire 262 and the second shading wire 264 have a continuously varying distance L2 between the second inclined segments 262b of the first shading wire 262 and the fourth inclined segments 264b of the second shading wire 264. The first flat segments 262c of the first shading wire 262 and the second flat segments 264c of the second shading wire 264 have a first distance L3 or a second distance L4 different from the first distance L3. This wire configuration can reduce spatial frequency interference in each of the stacked liquid crystal display panels, and prevent moire in the liquid crystal display device 10.

Furthermore, one of each pair of signal wires DL adjacent to each other is a third shading wire 272. The third shading wire 272 contains fifth inclined segments 272a and sixth inclined segments 272b. The fifth inclined segments 272a are acutely inclined in the counterclockwise direction relative to the +Y direction. The sixth inclined segments 272b are acutely inclined in the clockwise direction, opposite to the fifth inclined segments 272a, relative to the +Y direction. The other of the pair of signal wires DL adjacent to each other is a fourth shading wire 274. The fourth shading wire 274 contains seventh inclined segments 274a and eighth inclined segments 274b. The fourth shading wire 274 is symmetrical with the third shading wire 272 about the Y-axis direction. The seventh inclined segments 274a are opposed to the fifth inclined segments 272a of the third shading wire 272, and acutely inclined in the clockwise direction relative to the +Y direction. The eighth inclined segments 274b are opposed to the sixth inclined segments 272b of the third shading wire 272, and acutely inclined in the counterclockwise direction, opposite to the seventh inclined segments 274a, relative to the +Y direction. The third shading wire 272 and the fourth shading wire 274 have a continuously varying distance L5 therebetween. This wire configuration can reduce spatial frequency interference in each of the stacked liquid crystal display panels, and prevent moire in the liquid crystal display device 10.

The infrared camera 11 and the infrared sources 22 are disposed at any positions on the rear or −Z side in the lighting unit 20. For example, the infrared camera 11 disposed at the center of the display region as illustrated in FIG. 1 may be replaced with the infrared camera 11 disposed in the upper right portion, lower right portion, any other right portion, upper left portion, lower left portion, any other left portion, lower central portion, upper central portion, or any other central portion. The two infrared sources 22 disposed on the right and left sides of the infrared camera 11 as illustrated in FIG. 1 may be replaced with two infrared sources 22 disposed on the upper and lower sides or at any other positions, a single infrared source 22 at any position, or three or more infrared sources 22 at any positions. In accordance with these positions of the infrared camera 11 and the infrared sources 22, the position and size of the through hole 13H and the position and size of the second region 12F of the main surface 12B of the light guide plate 12 can be determined to ensure sufficient luminance of visible light and sufficient visibility of camera images.

The liquid crystal display device 10 according to the present disclosure is typically applicable to liquid crystal indicators of automobiles. The liquid crystal display device 10 may also be applied to display devices installed in aircrafts, trains, machine tools, or any other machines requiring driving operations. The liquid crystal display device 10 may also be applied to any electronic terminals that simultaneously require the display of an image and the monitoring of an operator, other than the machines requiring driving operations.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A lighting device, comprising:
a light guide plate; and
a light source to emit visible light to be incident to the light guide plate, wherein
the light guide plate includes
a first main surface through which the visible light is output, and
a second main surface opposite to the first main surface, and
the second main surface includes at least one light-distribution control structure that combines at least one light reflector and at least one infrared absorber.

2. The lighting device according to claim 1, wherein
the at least one light reflector is able to reflect, toward the first main surface, at least part of visible light propagating within the light guide plate,
the at least one infrared absorber is able to absorb at least part of infrared rays emitted from an exterior of the light guide plate to the second main surface, and
the second main surface of the light guide plate includes a region provided with the at least one light-distribution control structure, the region being able to transmit at least part of infrared rays propagating within the light guide plate from the first main surface to the second main surface.

3. The lighting device according to claim 1, further comprising:
an infrared source located outside the light guide plate to emit infrared rays to the second main surface; and
an infrared camera able to capture images using infrared rays propagating within the light guide plate from the first main surface to the second main surface.

4. The lighting device according to claim 3, further comprising:
a diffusion plate stacked on the first main surface of the light guide plate, wherein
the diffusion plate has an opening corresponding to a field of view (FOV) of the infrared camera, and
the at least one light-distribution control structure includes
a first light-distribution control structure in a diffusing area not overlapping with the opening of the diffusion plate, and
a second light-distribution control structure in a non-diffusing area overlapping with the opening of the diffusion plate.

5. The lighting device according to claim 4, wherein
the at least one light reflector includes
white reflectors made of dot-shaped coating to serve as the first light-distribution control structure, and
unit reflectors disposed on inner side surfaces of individual recesses on the light guide plate to serve as the second light-distribution control structure, and
the at least one infrared absorber includes
first unit absorbers disposed over the respective white reflectors to serve as the first light-distribution control structure, and
second unit absorbers provided within or on outer surfaces of the respective unit reflectors to serve as the second light-distribution control structure.

6. The lighting device according to claim 3, further comprising:
a diffusion plate stacked on the first main surface of the light guide plate, wherein
the diffusion plate has an opening corresponding to a field of view (FOV) of the infrared camera,
the second main surface of the light guide plate includes a non-diffusing area overlapping with the opening of the diffusion plate and a diffusing area not overlapping with the opening of the diffusion plate,
the diffusing area is provided with a light reflective sheet and an infrared absorption sheet different from the at least one light-distribution control structure,
the non-diffusing area is provided with the light-distribution control structure,
the at least one light reflector includes unit reflectors disposed on inner side surfaces of individual recesses on the light guide plate, and
the at least one infrared absorber includes unit absorbers disposed within or on outer surfaces of the respective unit reflectors.

7. The lighting device according to claim 1, wherein
the at least one light-distribution control structure includes grooves defined by linear recesses on the second main surface of the light guide plate,
the at least one light reflector includes unit reflectors disposed on inner side surfaces of the respective grooves, and
the at least one infrared absorber includes unit absorbers disposed within or on outer surfaces of the respective unit reflectors in the corresponding grooves.

8. The lighting device according to claim 7, wherein the grooves extend in a direction forming a predetermined angle from a propagation direction of visible light within the light guide plate, the visible light being emitted from the light source.

9. The lighting device according to claim 1, wherein
the at least one light-distribution control structure includes at least one groove defined by a recess having a shape corresponding to line segments that link connecting points at positions, each of the positions being defined by a radius and an angle randomly determined in a polar coordinate system having an origin at a reference point of an original basic geometry,
the at least one light reflector includes at least one reflector disposed on an inner side surface of the groove, and
the at least one infrared absorber includes at least one absorber disposed within or on an outer surface of the reflector provided to the corresponding groove.

10. The lighting device according to claim 1, wherein
the at least one light-distribution control structure includes recesses defined by punctate depressions at positions, each of the positions being defined by a radius and an angle randomly determined in a polar coordinate system having an origin at a reference point of an original basic geometry,
the at least one light reflector includes reflectors disposed on inner side surfaces of the respective recesses, and
the at least one infrared absorber includes absorbers disposed within or on outer surfaces of the respective reflectors provided to the corresponding recesses.

11. A light guide plate, comprising:
a first main surface through which visible light is output;
a second main surface opposite to the first main surface; and
an end face intersecting both the first main surface and the second main surface, the end face being able to receive visible light emitted from a light source, wherein
the second main surface has a specific region provided with at least one light-distribution control structure that combines at least one light reflector and at least one infrared absorber, and
the specific region is able to reflect at least part of visible light propagating within the light guide plate toward the first main surface, absorb at least part of infrared rays emitted from an exterior of the light guide plate to the second main surface, and transmit at least part of infrared rays propagating from the first main surface to the second main surface.

12. A display device, comprising:
a light guide plate including a first main surface through which visible light is output;
a diffusion plate stacked on the first main surface of the light guide plate;
a light source to emit visible light to be incident to the light guide plate; and
a display panel to display an image using the visible light output from the light guide plate and the diffusion plate, wherein
the light guide plate includes the first main surface and a second main surface opposite to the first main surface, and
the second main surface is provided with at least one light-distribution control structure that combines at least one light reflector and at least one infrared absorber.

13. The display device according to claim 12, further comprising:
an infrared source located outside the light guide plate to emit infrared rays to the second main surface; and
an infrared camera able to capture an image using infrared rays propagating within the light guide plate from the first main surface to the second main surface, wherein
the diffusion plate has an opening corresponding to a field of view (FOV) of the infrared camera,
the at least one light reflector is able to reflect, toward the first main surface, at least part of visible light propagating within the light guide plate,
the at least one infrared absorber is able to absorb at least part of infrared rays emitted from the infrared source to the second main surface, and
the light guide plate includes a non-diffusing area overlapping with the opening of the diffusion plate, the non-diffusing area being able to transmit infrared rays propagating within the light guide plate and entering the infrared camera.

14. The display device according to claim 13, wherein
the at least one light-distribution control structure includes
a first light-distribution control structure in a diffusing area not overlapping with the opening of the diffusion plate, and
a second light-distribution control structure in a non-diffusing area overlapping with the opening of the diffusion plate,
the at least one light reflector includes
white reflectors made of coating applied into dots to serve as the first light-distribution control structure, and
unit reflectors disposed on inner side surfaces of individual recesses on the light guide plate to serve as the second light-distribution control structure, and
the at least one infrared absorber includes
first unit absorbers disposed over the respective white reflectors to serve as the first light-distribution control structure, and
second unit absorbers provided within or on outer surfaces of the respective unit reflectors to serve as the second light-distribution control structure.

15. The display device according to claim 12, wherein
the at least one light-distribution control structure includes grooves defined by linear recesses on the second main surface of the light guide plate,
the grooves extend in a direction forming a predetermined angle from a propagation direction of visible light within the light guide plate, the visible light being emitted from the light source, and
the grooves are aligned at a pitch equal to or smaller than a pixel pitch of the display panel.

16. The display device according to claim 12, wherein
the at least one light-distribution control structure includes grooves defined by linear recesses on the second main surface of the light guide plate,
the grooves extend in a direction forming a predetermined angle from a propagation direction of visible light within the light guide plate, the visible light being emitted from the light source, and
each of the grooves has a second width larger than a first width indicating a line width of a black matrix of the display panel, the second width being less than 50% of a third width of each of transmissive portions of the display panel.

17. The display device according to claim 12, wherein
the at least one light-distribution control structure includes grooves defined by linear recesses on the second main surface of the light guide plate,
the grooves extend in a direction forming a predetermined angle from a propagation direction of visible light within the light guide plate, the visible light being emitted from the light source, and
the grooves form a predetermined inclination angle relative to a black matrix of the display panel.
